(19) United States
(12) Patent Application Publication
(10) Pub. No.: US 2011/0021698 A1
(43) Pub. Date: Jan. 27, 2011

(54) HYDROPHOBIC COATINGS

(76) Inventors: Jouko T. Vyörykkä, Richtershwil (CH); Pekka J. Salminen, Galgenen (CH); Etienne Lazarus, Marienthal (FR); Peter Sandkuehler, Tarragona (ES); Gerald A. Vandezande, Raleigh, NC (US); Kenneth W. Hester, Gambsheim (FR); Juergen Dombrowski, Halle (DE)

Correspondence Address: The Dow Chemical Company;Brooks, Cameron, PLLC, 1221 Nicollet Avenue, Suite 500, Minneapolis, MN, 55403, US

(21) Appl. No.: 12/735,490

(22) PCT Filed: Jan. 9, 2009
(86) PCT No.: PCT/US2009/000164

§ 371 Date: Oct. 5, 2010

Related U.S. Application Data
(60) Provisional application No. 61/011,911, filed on Jan. 22, 2008.

(51) Int. Cl. C08L 31/02; C08L 9/00

(52) U.S. Cl. 524/832; 524/836

(57) ABSTRACT

The present disclosure provides embodiments of polymeric particles, aqueous coating compositions, coating compositions, processes of making polymeric particles hydrophobic coatings, processes for making hydrophobic synthetic latex compositions, processes of forming polymeric particle agglomerates for use in a hydrophobic coating, and process of making hydrophobic polymeric binders. In some embodiments, the polymeric particle includes a polymer having an elastic modulus greater than about 10⁸ Pascal (Pa), measured at 25 degrees Celsius (° C.) and at a deformation frequency of 1 radian per second, where the polymeric particle is hydrophobic, and where the hydrophobicity is achieved by polymerizing a monomer in a mixture comprising water and a fatty acid, or salt thereof, where the monomer contains less than about 3 parts acid monomer per 100 parts dry monomer.

### FIELD OF THE DISCLOSURE

The present disclosure relates generally to coatings, and more particularly to hydrophobic, highly hydrophobic, and superhydrophobic coatings.

### BACKGROUND

Hydrophobic coatings applied to surfaces can provide the surfaces with the ability to repel water and/or self-clean. Such coatings can be used to render surfaces resistant to attachment by water-soluble electrolytes, such as acids and alkalies, dirt, and micro-organisms. Such coatings can also be used to render surfaces resistant to icing and fouling.

In order to achieve hydrophobicity and its accompanying self-cleaning characteristics, however, both a low surface energy and a degree of surface micro-roughness or micro-texture are necessary. Such a combination of low surface energy and surface micro-roughness can be found in nature. For example, lotus leaves are self-cleaning due to an inherently low surface energy coupled with a microstructured surface comprising pyramidal elevations spaced about a few micrometers apart.

In attempting to mimic such natural characteristics, there have been various approaches to the production of hydrophobic surfaces. Hydrophobic surfaces have been prepared, for example, by plasma processes, by vapor deposition, and by photolithography. Such methods have often not been suitable for industrial manufacturing, however, due to the need for multiple process steps and/or lengthy processing times. In addition, some of the surface textures resulting from these and other methods can be fragile and easily damaged.

### SUMMARY

The present disclosure provides embodiments of polymeric particles, aqueous coating compositions, coating compositions, processes of making polymeric particles, hydrophobic coatings, processes for making hydrophobic synthetic latex compositions, and processes of forming polymeric particle agglomerates for use in a hydrophobic coating. As discussed herein, embodiments of the polymeric particles, coating compositions and hydrophobic synthetic latex compositions include a polymer having an elastic modulus greater than about 10⁸ Pascal (Pa), measured at 25 degrees Celsius (° C.) and at a deformation frequency of 1 radian per second, where the polymeric particle is hydrophobic, and where the hydrophobicity of the polymeric particle is achieved by polymerizing a monomer, or more than one monomer, in a mixture comprising water and a fatty acid, or salt thereof, where the monomer contains less than about 3 parts acid monomer per 100 parts dry monomer.

The coating compositions and/or hydrophobic synthetic latex compositions can be used to coat a substrate to provide the coated substrate with desirable features (e.g., hydrophobicity, high hydrophobicity, superhydrophobicity).

For the various embodiments, the polymeric particles can have a variety of forms. For example, the polymeric particles can be discrete individual particles. In an alternative embodiment, the polymeric particles can be formed as an agglomerate, where two or more of the polymeric particles are joined together.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DEFINITIONS

As used herein, “a,” “an,” “the,” “at least one,” and “one or more” are used interchangeably. The term “comprises” and variations thereof do not have a limiting meaning where these terms appear in the description and claims.

The term “and/or” means one, more than one, or all of the listed elements.

The term “hydrophobic,” as used herein, refers to the property to repel water. A hydrophobic surface is a surface that provides a contact angle of more than 90° but less than 120° for a drop of water on the surface.

The term “highly hydrophobic” as used herein, refers to a surface that provides an equilibrium contact angle between 120° and 140° for a drop of water on the surface.

The term “superhydrophobic,” as used herein, refers to a surface that provides a contact angle higher than 140° for a drop of water on the surface.

“Polymeric binder,” as used herein, refers to a binder that is a polymer.

“Hydrophobic polymeric binder,” as used herein, refers to a polymeric binder that when applied to a substrate surface and allowed to form a film, forms a film on the surface that produces a contact angle greater than 90° for a drop of water on the surface.

“Synthetic latex,” as used herein, refers to a stable dispersion of polymer particles in an aqueous medium.

Also herein, the recitations of numerical ranges by endpoints include all numbers subsumed within that range (e.g., 1 to 5 includes 1, 1.5, 2, 2.75, 3, 3.80, 4, 5, etc.).

### DETAILED DESCRIPTION

The present disclosure provides embodiments of polymeric particles, aqueous coating compositions, coating compositions, processes of making polymeric particles hydrophobic coatings, processes for making hydrophobic synthetic latex compositions, processes for making hydrophobic polymeric binders, and processes of forming polymeric particle agglomerates for use in a hydrophobic coating.

Hydrophobicity can be measured by the affinity of a solid surface for water, also referred to as wettability. The wettability of a surface is dependent on both the physical and chemical heterogeneity of the surface and has been measured by the contact angle made by a droplet of water on the surface of the solid surface. If the water spreads completely across the surface and forms a film, the contact angle is equal to 0°. If the contact angle is greater than 90°, the surface is considered to be non-wetting.

As discussed herein, a surface is considered to be hydrophobic if the contact angle of a droplet of water is greater than 90°. Coatings on which water has a contact angle greater than 90° are referred to as hydrophobic coatings. In addition, surfaces with water contact angles greater than 120°, but below 140°, are referred to as highly hydrophobic. Similarly, coatings on which water has a contact angle greater than 140° are referred to as superhydrophobic coatings.

A superhydrophobic surface can be developed on a substrate through development of both a rough surface topology and chemistry providing low surface energy on the surface. One skilled in the art will appreciate that the presence of a relatively high degree of surface roughness can provide for at least two contact effects between the rough surface and materials that can come into contact with the rough surface. First, the existence of a high degree of surface roughness can provide for a very small contact area between the surface and a contaminant (e.g., a particulate or an aqueous liquid droplet) that can come into contact with the surface. As such, adhesion between the contaminant and the surface can be minimized due to the minimal contact area between the two. Second, the surface roughness can facilitate the trapping of air beneath a portion of the contaminant. For instance, when considering a liquid droplet coming into contact with the rough surface, an air boundary layer can form between portions of the droplet and the surface; this air boundary layer can further increase the contact angle between the droplet and the surface.

Although surface roughness can provide a surface with some degree of hydrophobicity, hydrophobicity can be further enhanced when combined with a surface chemistry providing a low surface energy. Thus, when a solid particulate or a liquid droplet, (e.g., a water droplet) contacts the surface, it can easily roll or slide off of the surface due to the combined effects of surface roughness and low surface energy. Also, when considering a liquid droplet, as the droplet rolls or slides off of the surface and in so doing encounters a solid particle on the surface, the particle can adhere to the passing droplet and can simultaneously be removed from the surface with the liquid, as adhesion between the surface and the particle has been minimized, as described herein. Thus, the particle can preferentially adhere to the liquid and be “cleaned” from the rough surface.

Embodiments of the present disclosure can be used without non-aqueous solvents, fluorochemicals, silanes, and/or nanoparticles or nanofibers, and do not require chemical vapor deposition. In addition, embodiments of the present disclosure are not based on physical rupturing of a hydrophobic surface. Rather, the properties of the coating compositions (rheology, solids content, etc.) are suitable for application with conventional application techniques and also do not require further process steps once the coating compositions are applied to the substrate surface.

Embodiments of the present disclosure include polymeric particles and a process of making the polymeric particles in an aqueous dispersion. The polymeric particles can be produced in a process including polymerizing a monomer in a mixture including water, a fatty acid, or salt thereof, and the monomer, where the monomer contains less than 3 parts acid monomer per 100 parts dry monomer under conditions sufficient to produce an aqueous dispersion of polymeric particles. The polymeric particles include a polymer with elastic modulus greater than about 10⁸ Pa, measured at 25° C. and at a deformation frequency of 1 radian per second. As appreciated by one skilled in the art, the elastic modulus is a measure of the softness or stiffness of the polymeric particle. By including a polymer with an elastic modulus greater than 10⁸ Pa, the polymeric particles show resistance to deformation which can aid in providing surface roughness to a surface, enhancing the hydrophobicity of the surface, as discussed herein. In addition, the elastic modulus is measured at 25° C. and at a deformation frequency of 1 radian per second in order to correspond to a median range frequency at room temperature.

In some embodiments, the acid monomer can be selected from a group including acrylic acid, methacrylic acid, itaconic acid, fumaric acid, maleic acid, and mixtures thereof.

In various embodiments, the polymeric particles can have a volume average particle diameter in a range of about 30 nanometers to about 5,000 nanometers. In some embodiments, the polymeric particles can have a volume average particle diameter in a range of about 60 nanometers to about 500 nanometers.

As discussed herein, the polymeric particles are hydrophobic, where the hydrophobicity of the polymeric particle can be achieved by polymerizing a monomer in a mixture comprising water, a fatty acid, or salt thereof, and the monomer, where the monomer contains less than about 3 parts acid monomer per 100 parts dry monomer. Other methods of polymerizing the monomer to achieve polymeric particles can also be used. For example, in various embodiments, polymerizing the monomers in the mixture of water and the fatty acid, or salt thereof, can include polymerizing by at least one of emulsion polymerization, miniemulsion polymerization, and dispersion polymerization.

As used herein, “emulsion polymerization” refers to a polymerization process incorporating, for example, water, monomer, and surfactant, as will be known by one skilled in the art. Similarly, as used herein, “miniemulsion polymerization” refers to the process in which stable nanodroplets of one phase are dispersed in a second, continuous phase, as will be recognized by one skilled the art. As used herein, “dispersion polymerization” refers to different types of polymerization processes where an organic phase (e.g., monomer), is dispersed in an aqueous phase (e.g., water). Exemplary dispersion polymerization processes can include suspension polymerization, surface-initiated graft polymerization, two-step emulsion polymerization, in situ polymerization, and micro-emulsion polymerization, among others.

In some embodiments, the fatty acid, or salt thereof, can be added during the polymerization of the monomer in the mixture to produce the aqueous dispersion of polymeric particles. In some embodiments, the amount of fatty acid, or salt thereof, added to the mixture can be in a range of about 0.2 parts per 100 parts dry monomer to about 5 parts per 100 parts dry monomer.

In some embodiments, the fatty acid, or salt thereof, can serve as a surfactant in the polymerization process. As used herein, “surfactant” refers to an agent that can lower the interfacial tension between a polymer and water and also stabilize the polymeric particles during the polymerization process. In addition, since the fatty acid, or salt thereof, can contain both a hydrophobic portion (e.g., their “tails”), and a hydrophilic portion (e.g., their “heads”), the fatty acid can be soluble in both organic solvents and in water.

In various embodiments of the present disclosure, the fatty acid, or salt thereof, can have 8 to 22 carbon atoms, and more preferably 10 to 18 carbon atoms. Particularly preferred fatty acids are selected from the group including oleic acid, stearic acid, palmitic acid, linoleic acid, linolenic acid, and combinations thereof. Also preferred are salts of the latter fatty acids. The counter ions of a fatty acid salt can also be a suitable ion. Examples include sodium ions and ammonium ions. Mixtures of fatty acids and/or their salts can also be employed. Advantages of using one or more fatty acids can include that fatty acids are inexpensive compared to silanes and fluorinated polymers and are readily available and used in many industries.

As discussed herein, in some embodiments, polymeric particles can be included in a composition, for example, a coating composition. The coating composition can be an aqueous coating composition including the polymeric particles, as discussed herein, an amount of polymeric binder in a range of about 5 parts per 100 parts polymeric particle to about 70 parts per 100 parts polymeric particle, and water. The polymeric binder can serve to bind the polymeric particles together and also to bind the polymeric particles to a substrate once the coating composition is applied to the substrate and allowed to dry.

In some embodiments, the polymeric binder can be selected from a group including synthetic latex, proteins, cellulose, cellulose derivative, polyvinyl alcohol, polysaccharide, polyvinyl pyrrolidone, polyvinyl acetate, epoxy acrylate, polyester, polyesteracrylate, polyurethane, polyetheracrylate, polyolefin dispersion, nitrocellulose, polyamide, vinyl copolymer, and polyacrylate, and combinations thereof.

Examples of polymeric binders include styrene-butadiene latex, styrene-acrylate latex, styrene-butadiene-acrylonitrile latex, acrylate latex, styrene-maleic anhydride latex, styrene-acrylate-maleic anhydride latex, polysaccharides, proteins, polyvinyl pyrrolidone, polyvinyl alcohol, polyvinyl acetate, cellulose and cellulose derivatives, epoxyacrylates, polyester, polyesteracrylates, polyurethanes, polyetheracrylates, oleoresins, nitrocellulose, polyamide, vinyl copolymers, various forms of polyacrylates, and copolymers of vinyl acetate, (meth)acrylic acid, and vinyl versatate. Examples of polysaccharides include starch, carboxymethylated starch, agar, and sodium alginate. Examples of proteins include albumin, soy protein, and casein. Mixtures of binders can also be employed.

Examples of preferred polymeric binders include polyvinylalcohol, starch, proteins, cellulose derivatives, and carboxylated latex. The preferred carboxylated latex is a synthetic latex stabilized predominantly by carboxylation, or a fatty acid, or salt thereof. Preferably the glass transition temperature of the polymeric binder is in the range from about −40° C. to about 80° C., and more preferably from about 0° C. to about 50° C. Examples of the polymeric binder include the commercially available binders available from The Dow Chemical Company under the trade names UCAR Latex 123, UCAR Latex 169s, UCAR Latex 629, and NeoCAR Acrylic 820.

The synthetic latexes used as polymeric binders can be an aqueous dispersion of polymeric particles prepared by polymerization of one or more monomers.

The monomer composition employed in the preparation of the synthetic latex can include from about 10 to 95 pphm of a first monomer (A), from about 5 to 90 pphm of a second monomer (B), and from 0 to about 5 pphm of a functional monomer (C). As used herein, the term “pphm” means parts per hundred monomer, a term known to those skilled in the art. Accordingly, the total parts monomer employed is 100 parts monomer, on a weight basis.

The first monomer (A) can be a monomer that provides a low T_{g} polymer, preferably comprising an alkyl acrylate or butadiene. The monomer is used in amounts of from about 10 pphm to about 95 pphm, preferably 20 pphm to 50 pphm. Examples of monomers that can provide a low T_{g} polymer, including polymers produced having a T_{g} of less than 10° C., are C₁-C₁₀ alkyl esters of acrylic acid, C₂-C₁₀ alkyl esters of alpha, beta-ethylenically unsaturated C₄-C₆ monocarboxylic acids, C₄-C₁₀ dialkyl esters of alpha, beta-ethylenically unsaturated C₄-C₈ dicarboxylic acids, and vinyl esters of carboxylic acids, including, without limitation, vinyl isobutyrate, vinyl-2-ethyl-hexanoate, vinyl propionate, vinyl isooctanoate and vinyl versatate and butadiene. The monomer can be selected from the group including, but not limited to, C₁-C₁₀ alkyl esters of (meth)acrylic acid (i.e. alkyl (meth)acrylates), and C₄-C₈ dialkyl esters of maleic, itaconic and fumaric acids. Preferably, at least one C₂-C₈ alkyl ester of acrylic acid is utilized. Preferred monomers can include ethyl acrylate, butyl acrylate, 2-ethyl hexyl acrylate, decyl acrylate, dibutyl maleate, dioctyl maleate, and butadiene with butadiene being most preferred. Mixtures of two or more of first monomers can be employed.

The second monomer (B) can be a monomer that can provide a high T_{g} polymer, where the polymer can have a T_{g} greater than 10° C. such as, for example, vinyl esters of carboxylic acids, the acid having from two to about 13 carbon atoms, and styrene. Representative comonomers include methyl methacrylate, dimethyl maleate, t-butyl methacrylate, t-butyl isobornyl acrylate, phenyl methacrylate, acrylonitrile, vinyl esters of carboxylic acids producing polymers having a T_{g} of greater than 10° C., and styrene. Examples of such vinyl esters include vinyl pivalate, vinyl neodecanoate, vinyl neononanoate, and mixtures of branched vinyl esters such as the commercially available VeoVa 11 (Hexion Specialty Chemicals) and EXXAR Neo-12 (Exxon Chemical Company). The second monomer advantageously is employed in an amount of from about 5 pphm to about 90 pphm, preferably about 50 pphm to about 80 pphm.

It may also be desired to incorporate in the polymeric binder minor amounts of a functional monomer (C). Examples of suitable functional monomer (C) include: acrylic acid; methacrylic acid; itaconic acid; fumaric acid; the half esters of maleic acid, such as monoethyl, monobutyl or monooctyl maleate; acrylamide; tertiary octylacrylamide; N-methylol (meth)acrylamide; N-vinylpyrrolidinone; diallyl adipate; triallyl cyanurate; butanediol diacrylate; allyl methacrylate; etc.; as well as C₂-C₃ hydroxyalkyl esters such as hydroxyethyl acrylate, hydroxy propyl acrylate, and corresponding methacrylates. The monomer (C) generally is used at levels of less than 5 pphm, preferably less than 2.5 pphm, depending upon the nature of the specific monomer. Mixtures of monomer (C) can be employed.

In addition, certain copolymerizable monomers that assist in the stability of the polymeric binder, e.g., vinyl sulfonic acid, sodium vinyl sulfonate, sodium styrene sulfonate, sodium allyl ether sulfate, sodium 2-acrylamide-2-methyl-propane sulfonate (AMPS), 2-sulfoethyl methacrylate, and 2-sulfopropyl methacrylate, can be employed as emulsion stabilizers. These optional monomers, if employed, are added in very low amounts of from 0.1 pphm to about 2 pphm.

Methods for preparing synthetic latexes are well known in the art and can be used to prepare the synthetic latexes.

Suitable free radical polymerization initiators are the initiators known to promote emulsion polymerization and include water-soluble oxidizing agents, such as organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.), and those initiators that are activated in the water phase by a water-soluble reducing agent. Such initiators are employed in an amount sufficient to cause polymerization. As a general rule, a sufficient amount is from about 0.1 pphm to about 5 pphm. Alternatively, redox initiators may be employed, especially when polymerization is carried out at lower temperatures. For example, reducing agents may be used in addition to the persulfate and peroxide initiators mentioned above. Typical reducing agents include, but are not limited to, alkali metal salts of hydrosulfites, sulfoxylates, thiosulfates, sulfites, bisulfites, reducing sugars such as glucose, sorbose, ascorbic acid, erythorbic acid, and the like. In general, the reducing agents are used at levels from about 0.01 pphm to about 5 pphm.

Emulsifying agents generally known in emulsion polymerization processes can be used in embodiments of the present disclosure. The emulsifiers can be anionic, cationic, surface-active compounds or mixtures thereof.

Suitable nonionic emulsifiers include polyoxyethylene condensates. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic emulsifying agents that can be used also include a series of surface active agents available from BASF under the PLURONIC and TETRONIC trade names. In addition, a series of ethylene oxide adducts of acetylenic glycols, sold commercially by Air Products under the SURFYNOL trade name, are suitable as nonionic emulsifiers.

Representative anionic emulsifiers include the alkyl aryl sulfonates, alkali metal alkyl sulfates, the sulfonated alkyl esters, and fatty acids and salts thereof. Specific examples include sodium dodecylbenzene sulfonate, sodium butylnaphthalene sulfonate, sodium lauryl sulfate, disodium dodecyl diphenyl ether disulfonate, N-octadecyl sulfosuccinate, dioctyl sodiumsulfosuccinate, oleic acid, stearic acid, palmitic acid, and their salts. The emulsifiers are employed in amounts effective to achieve adequate stabilization of the polymer particles in the aqueous phase and to provide desired particle size and particle size distribution without negatively impacting the hydrophobic properties of the aqueous coating composition.

Other ingredients known in the art to be useful for various specific purposes in emulsion polymerization, such as acids, salts, chain transfer agents, chelating agents, buffering agents, neutralizing agents, defoamers, and plasticizers also may be employed in the preparation of the synthetic latex. For example, if the polymerizable constituents include a monoethylenically unsaturated carboxylic acid monomer, polymerization under acidic conditions (pH 2 to 7, preferably 2 to 5) is preferred. In such instances the aqueous medium can include those known weak acids and their salts that are used to provide a buffered system at the desired pH range.

Various protective colloids may also be used in place of, or in addition to, the emulsifiers described above in the preparation of the synthetic latex. Suitable colloids include casein, hydroxyethyl starch, carboxyxethyl cellulose, carboxymethyl cellulose, hydroxyethylcellulose, gum arabic, alginate, poly(vinyl alcohol), polyacrylates, polymethacrylates, styrene-maleic anhydride copolymers, polyvinylpyrrolidones, polyacrylamides, polyethers, and the like, as known in the art of emulsion polymerization technology.

The manner of combining the polymerization ingredients for the production of a synthetic latex can be by various known monomer feed methods, such as continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

The final particle size of the synthetic latex advantageously can vary from 30 nm to 1500 nm.

The amount of polymeric binder can be high enough so that the coating exhibits the desired adhesion, mechanical strength, and hydrophobicity, but on the other hand the amount of polymeric binder preferably is not so high that the hydrophobicity of the coating is reduced by the binder submerging the polymeric particles and/or polymeric particle agglomerates. A person skilled in the art can, in the light of this description, adjust the amount of polymeric binder within the range of the appended claims.

The degree of carboxylation for a carboxylated latex should be adapted relative to the required stability and hydrophobicity.

Further, the coating composition can also include additives selected from a group including fatty acid, polyvalent salt, coagulant, rheology modifier, and colorant, and combinations thereof.

In addition, in some embodiments, the coating composition can include inorganic particles. The inorganic particles can be at least one substance selected from the group including aluminum hydroxide, aragonite, barium sulphate, calcite, calcium sulphate, dolomite, magnesium hydroxide, magnesium carbonate, magnesite, magadiite, ground calcium carbonate, precipitated calcium carbonate, titanium dioxide (e.g. rutile and/or anatase), satin white, zinc oxide, silica, alumina trihydrate, mica, talc, clay, calcined clay, diatomaceous earth, vaterite, and combinations thereof. The inorganic particles are preferably calcium carbonate particles, more preferably precipitated calcium carbonate, and most preferably aragonite.

As discussed herein, a hydrophobic, highly hydrophobic, and/or superhydrophobic coating can be formed by combining a rough surface topology and low surface energy chemistry on the surface of a substrate. When applied to a substrate, the polymeric particles, as discussed herein, can form the rough surface topology on the substrate. In addition, the hydrophobicity of the polymeric particles can add to the hydrophobicity of the coating when applied to the substrate.

In some embodiments, the polymeric particles can have a spherical shape. Other shapes are also possible. In some embodiments, the polymeric particles can be used to form polymeric particle agglomerates with a more irregular surface structure as compared to the polymeric particles individually. The irregular surface structure can increase the roughness of the surface topology when the polymeric particle agglomerates are applied to the surface of a substrate.

There are several ways in which the polymeric particles can be agglomerated to form the polymeric particle agglomerates. As discussed herein, the polymeric particles can be formed in an aqueous dispersion. As such, in some embodiments, the polymeric particles in the aqueous dispersion can be spray dried to form the polymeric particle agglomerates. Spray drying can offer an opportunity to control the agglomerate sizes produced.

For example, the polymeric particles can have a volume average particle diameter in a range of about 10 nanometers to about 5,000 nanometers, preferably about 50 nanometers to about 1,000 nanometers, and even more preferably about 60 nanometers to about 500 nanometers, when in the aqueous dispersion. The polymeric particle size can be controlled by manipulating the polymerization conditions, such as surfactant concentration, seed concentration, polymerization rate, catalyst or initiator concentration, reaction temperature, and the like. In addition, one of ordinary skill in the art will appreciate that the many known emulsion polymerization techniques, such as emulsion, micro-emulsion, mini-emulsion, and the like can be used to control the polymeric particle size.

Upon spray-drying, the polymeric particles can agglomerate into polymeric particle agglomerates with a volume average particle diameter in a range of about 0.5 micrometer to about 500 micrometers, preferably about 0.8 micrometer to about 100 micrometers, even more preferably about 1 micrometer to 50 micrometers.

To spray dry the polymeric particles, several methods can be used. In some embodiments, the polymeric particles can be suspended in the aqueous dispersion, discussed herein, and then forced at high pressure through a small orifice onto a surface. For example, the surface can be a Teflon film and/or a wall. Other surfaces are also possible. The deposited polymeric particle agglomerates can then be allowed to dry, or otherwise separated from the aqueous dispersion. For example, the polymeric particle agglomerates can be dried using drying techniques such as heating, vacuum, freeze drying, evaporation, and the like. In addition, both conventional hot air drying and fluid energy mill drying can be used.

The polymeric particle agglomerates can also be “dried” several times. For example, the polymeric particle agglomerates can be freeze-dried to a water free state, suspended in an alcohol, then spray dried to achieve a final agglomerated form.

Of the many methods and equipment available to spray dry a substance the present disclosure will only list a few for convenience and brevity. However this in no way should be construed as limiting the embodiments of the present disclosure. Some known commercial spray dryers are manufactured by Niro Atomizer, Inc., Beckman, Stork-Bowen Engineering, Inc. and Swenson Process Equipment. Further information on spray drying techniques is located at page 96 to 99 in volume 21 of the Kirk-Othmer Encyclopedia of Chemical Technology, 3rd Ed. published by John Wiley and Sons, New York; and in Impact of Spray Dryer Design on Powder Properties, Masters, Keith (Niro/Soeborg DK-2860, Den.) Drying 91, [Sel. Pap. Int. Drying Symp.] 7th meeting date 1990, 56-73; Analysis of Spray Drying Systems, Holm Petersen, J. E., Agarwal, H. C. (Larsen and Toubro Ltd, Bombay India) Chem Age India, 21 (3) 227-34, 1970; and Spray Drying: A Traditional Process for Advanced Applications, Shaw, Fred, AM. Ceram. Soc. Bull., 69(9) 1484-9, 1990.

The size of the polymeric particle agglomerates can be controlled by varying the nozzle size, nozzle type, pressure, and shear rates, and the like, of the spraying apparatus.

In addition to spray drying, the polymeric particles in the aqueous dispersion can be agglomerated with either a polyvalent salt in an aqueous solution or with a cationic polymer in an aqueous solution. Examples of agglomerating polymeric particles can be found in EP Patent No. EP1784537 to Tsavalas et al.

Suitable agglomerating agents include, for example: cationic polymers such as cetyl pyridinium chloride, quaternary ammonium salts, and ethoxylated quaternary ammonium salts; positively, negatively, or amphoterically charged polyelectrolytes such as cationic starch, cationic polyacrylamide, polyethyleneimine (PEI), polyacrylamide-co-acrylic acid, poly(diallyldimethylammonium chloride) (PDADMAC), and the like; neutral water-soluble polymers such as, for example, polyethylene oxide (PEO), and partially hydrolyzed polyvinyl acetate; and agglomerating salts such as, for example, calcium chloride, zinc chloride, aluminum chloride, and ammonium sulfate.

A colloidally stabilized particle to which the polymeric particles adhere can also be a suitable agglomerating agent. Examples of such agglomerating agents include cetyl pyridinium chloride and poly(diallyldimethylammonium chloride). Mixtures of agglomerating agents can also be employed. The agglomerating agent is employed in an amount sufficient to form an agglomeration of the polymeric particles.

In some embodiments, the amount of agglomerating agent is sufficient to convert at least about 50 weight percent of the solids of the polymeric particles to agglomerates. In additional embodiments, the agglomerating agent can be sufficient to convert about 50 weight percent to about 100 weight percent polymeric particles to agglomerates.

For the various embodiments, from about 0.02 to about 0.04 grams of agglomerating agent can be employed per gram of solids of the polymeric particles. In an additional embodiment, about 0.03 grams of agglomerating agent can be employed per gram of solids of the polymeric particles.

As discussed herein, a hydrophobic coating and/or a hydrophobic coating composition can be produced using the polymeric particles. Similarly, in some embodiments, the polymeric particle agglomerates can be used to produce a hydrophobic coating, and/or a hydrophobic coating composition. In some embodiments, a hydrophobic coating prepared from the coating composition where the polymeric particles are agglomerated into polymeric particle agglomerates can be superhydrophobic. In addition, in some embodiments, the polymeric particle agglomerates can be mixed with a hydrophobic polymeric binder, as discussed herein, to form the hydrophobic coating composition.

Embodiments of the present disclosure include a process for making a hydrophobic synthetic latex composition with the polymeric particles. The process includes polymerizing monomers comprising less than about 3 parts acid monomer per 100 parts dry monomer by at least one of emulsion polymerization, mini-emulsion polymerization, and dispersion polymerization, as discussed herein. In such embodiments, the monomers are selected from the group of: alkyl acrylate, butadiene, C₁-C₁₀ alkyl esters of (meth)acrylic acid, C₄-C₈ dialkyl esters of maleic, itaconic and fumaric acids, vinyl esters of carboxylic acids, styrene, and mixtures thereof to produce polymeric particles. The process can also include mixing a hydrophobic polymeric binder in water with the polymeric particles, where the polymeric particles contain a polymer with an elastic modulus greater than about 10⁸ Pa, measured at 25° C. and at a deformation frequency of 1 radian per second, and adding a fatty acid, or salt thereof, to form the hydrophobic synthetic latex composition.

As used herein, “hydrophobic polymeric binder” refers to a polymeric binder that can be applied to a substrate surface to form a film on the substrate surface, where the contact angle made by a droplet of water on the surface of the film has a contact angle greater than 90°.

In some embodiments, the fatty acid, or salt thereof, can be added during the polymerization of the monomers to produce the polymeric particles. In various embodiments, the fatty acid, or salt thereof, can be added after the polymerization of the monomers to produce polymeric particles. In addition, in some embodiments, the fatty acid, or salt thereof, can be added in a range of about 0.2 parts per 100 parts dry monomer to about 5 parts per 100 parts dry monomer.

Embodiments of the present disclosure also include a process for making a hydrophobic polymeric binder, as discussed herein. The hydrophobic polymeric binder can be used as a hydrophobic synthetic latex composition. The process for making the hydrophobic polymeric binder includes polymerizing monomers, where the monomers contain less than 3 parts acid monomer per 100 parts dry monomer, by at least one of emulsion polymerization, miniemulsion polymerization, and dispersion polymerization, where the monomers are selected from a group of alkyl acrylate, butadiene, C₁-C₁₀ alkyl esters of (meth)acrylic acid, C₄-C₈ dialkyl esters of maleic, itaconic and fumaric acids, vinyl esters of carboxylic acids, styrene, and mixtures thereof to produce polymers in an aqueous dispersion, and adding a fatty acid, or salt thereof, to the aqueous dispersion.

In some embodiments, the fatty acid, or salt thereof, can be utilized as a surfactant in the polymerization process, as discussed herein. In addition, the fatty acid, or salt thereof, can be added to the aqueous dispersion at various times in the polymerization process, including after the polymerization or during the polymerization of the monomers.

In various embodiments, the hydrophobic polymeric binder can be applied to a substrate to produce a film on the substrate. The film, when dried, can have a contact angle measurement of from about 100° to about 115°. In addition, as discussed herein, the hydrophobic polymeric binder can be used as a hydrophobic synthetic latex composition.

Embodiments of the present disclosure include coating compositions, hydrophobic coatings, and hydrophobic synthetic latex compositions including polymeric particles and/or polymeric particle agglomerates formed from the polymeric particles. As discussed herein, the coating composition can be an aqueous dispersion. As such, the process for making the hydrophobic coating can include contacting the aqueous dispersion with a substrate. The substrate can be formed, by way of example, of paper, plastic, wood, contrast chart, steel, eternity, and/or plaster board, among others. Contacting the aqueous dispersion with the substrate is performed by a method selected from a group including: spray coating, dip coating, roll application, free jet application, blade metering, rod metering, metered film press coating, air knife coating, curtain coating, flexography printing, roll coating, and powder coating, among others.

Preferably the coating according to the present disclosure is highly hydrophobic, i.e. the surface formed with the coating displays an equilibrium contact angle between 120° and 140°. More preferably the contact angle is higher than 135°. Using the present disclosure, it is even possible to manufacture superhydrophobic coatings, which display an equilibrium contact angle greater than 140°.

Advantages of embodiments of the present disclosure include, for example, a coating that can be applied in one step, a coating that is non-toxic, is approved for food contact, is inexpensive, and can be produced in an environmentally friendly manner. A further advantage is that existing industrial coating processes can be used for applying the coating. Another advantage is that a hydrophobic surface is created without need for stamping or etching.

The following examples are provided for illustrative purposes and are not intended to limit the scope of the disclosure since the scope of the present disclosure is limited only by the appended claims and equivalents thereof. All parts and percentages are by weight unless otherwise indicated.

### SPECIFIC EMBODIMENTS

If not otherwise indicated, the following methods apply to all examples described herein.

### Dry Stain Size Measurement

In the stain test, 5 drops of an exact amount (9 μl, i.e. drop diameter 2.58 mm) of a blue dye aqueous solution are auto-pipetted (from a fixed height of 1.9 mm from drop bottom to coat surface) on the coated surface. The blue dye is added to aid visual inspection of stain size after complete evaporation of the water. The surface tension of the colored water is the same as the non-colored deionized water. The samples are stored at 23° C. and 50% relative humidity, and the final size of the dry stain after complete evaporation is measured with a sliding gauge. The values given below correspond to the mean of the set of 5 drops measured. They are expressed in a dimensionless form by dividing the stain diameter by the drop diameter prior to contact (i.e. 2.58 millimeters). This measure relates to the total ability of the substrate to resist both surface spreading and sub-surface penetration, and spreading (within the top coating layer and layers below) over long times. A hydrophobic surface leads to a smaller stain diameter than the initial droplet diameter. This method can be used to rank the samples' performance regarding hydrophobicity.

### Contact Angle Measurement

Short-time contact angles of drops of deionized water (i.e. without the blue dye) on the coated sheets are measured with a Fibro-DAT 1100 contact angle instrument, using the dropping procedure (i.e. 5 drops at different places) as in the staining experiments described above. The time from contact to measurement of advancing angle is about 1-2 seconds (s). This is a standard measure of short-term hydrophobicity, reflecting the ability of the substrate to reject water drops on first contact.

### Rolling Angle Measurement

The drop rolling tests are performed using a tilt table. The same blue dye solution as mentioned above is autopipetted in a similar manner as in the stain test on the coated samples pre-inclined at 5 fixed angles (2.5°, 5°, 10°, 15° and 20° from horizontal). The lowest angle for which free rolling occurs, i.e. the drop rolls the entire distance of the sample size (around 10 centimeters (cm)), is the value assigned to the substrate. Failure to roll freely at 20° is regarded as a no-score, despite the fact that free rolling may occur at higher angles not tested (e.g. approaching vertical). It is expected that drop rolling is closely dependent on advancing initial contact angle (see above).

### Cobb Test

The Cobb test is performed according to Tappi standard T-441 om-90.

### Elastic Modulus Measurement

Elastic modulus is a coefficient of elasticity representing the ratio of stress to strain as a material is deformed under dynamic load. In the Examples herein, elastic modulus is measured with a Dynamic Mechanical Spectrometer (available from Rheometric Scientific Inc., Poscataway, N.J., USA). A shear strain is applied by a motor at a selected deformation frequency, the resulting torque is measured by a transducer and mathematically (based on the sample geometry) converted into elastic modulus. The frequency of 1 radian per second is chosen as corresponding to a median range frequency.

### Particle Size Measurement

The volume average particle diameter of the polymeric particles are measured using a Nanotrac 150 (available from Microtrac, Inc., Montgomeryville, Pa., USA)

### Example 1

Three latexes are modified by removing the surfactant present in the latex and replacing the surfactant with a fatty acid. More specifically, the fatty acid is oleic acid. The fatty acid can be used as a surfactant. The latexes using the fatty acid can be used as a hydrophobic polymeric binder and/or a hydrophobic synthetic latex composition, as discussed herein.

The formulations for the monomer feed to form the latexes are shown in TABLE 1 below. Contact angle measurements are performed on 1.5 millimeters (mm) thick dried coatings made from the latexes, the contact angle measurements are shown in TABLE 2 below.

TABLE 1

| Latex | Monomer Feed | Weight (Grams) | PPHM (Wet) |
|---|---|---|---|
| 1 | Water (DI) | 350.0 | 28.3 |
| | Rhodacal A-246L | 58.5 | 4.7 |
| | Methacrylic Acid, | 12.5 | 1.0 |
| | Glacial | | |
| | Butyl Acrylate MEHQ | 1060.0 | 85.6 |
| | Methyl Methacrylate | 171.0 | 13.8 |
| 2 | Oleic Acid | 27.0 | 2.2 |
| | Butyl Acrylate MEHQ | 1060.0 | 86.4 |
| | Methyl Methacrylate | 171.0 | 13.9 |
| | Water (DI) | 350.0 | 28.54 |
| 3 | Methyl Methacrylate | 113.47 | 8.03 |
| | Butyl Acrylate MEHQ | 706.71 | 50.0 |
| | Oleic Acid | 24.82 | 1.76 |
| | 2-Ethylhexyl Acrylate | 285.26 | 20.18 |
| | Isooctyl 3- | 2.20 | 0.16 |
| | Mercaptopropionate | | |
| 4 | Methyl Methacrylate | 113.47 | 8.03 |
| | Butyl Acrylate MEHQ | 706.71 | 50.0 |
| | Methacrylic Acid, | 22.60 | 1.60 |
| | Glacial | | |
| | 2-Ethylhexyl Acrylate | 285.26 | 20.18 |
| | Aerosol TR 70 HG | 1.50 | 0.11 |

TABLE 2

| Latex | Contact Angle ° |
|---|---|
| 1 | 46° |
| 2 | 113° |
| 3 | 112° |
| 4 | 67° |

As can be seen from Table 1 and Table 2, when the monomer feed contains a fatty acid, specifically oleic acid, the contact angle increases as compared to when the monomer feed does not contain oleic acid.

### Example 2

To form polymeric particle agglomerates, the polymeric particles are agglomerated using one of three methods, salt-initiated agglomeration, agglomeration with cationic polymer, and spray-drying processes.

In this example, the salt-initiated agglomeration method is provided.

Agglomeration is carried out in a stirred vessel. The vessel dimensions are a volume of 2.5 liter (L), diameter of 150 mm, height of 150 mm, baffles of 4 cylinders having a diameter of 12 mm, where the baffles are located 55 mm from the center. The impeller is a Rushton Turbine, 50 mm from the bottom of the vessel with ports located at the bottom, 40 mm from the center. Table 3 presents the latex composition, referred to as Polymeric Particle Dispersion 1.

TABLE 3

| Stream | Component | Parts | Weight (Grams) |
|---|---|---|---|
| A | DI Water | 212.721 | 1513.05 |
| | Sodium Bicarbonate | 0.200 | 1.42 |
| | Seed Latex (38%) | 0.124 | 2.33 |
| | Versenol 120 (1%) | 0.010 | 7.11 |
| B | Styrene | 100.00 | 711.28 |
| | Oleic Acid | 2.000 | 14.23 |
| C | DI Water | 26.00 | 184.93 |
| | Sodium Persulfate | 0.700 | 4.98 |
| | Sodium Hydroxide (20%) | 0.300 | 10.67 |

Polymeric Particle Dispersion 1 presented in Table 3 has a measured solids content of 30 percent and the extrapolated elastic modulus, G′, of the polymeric particles at a temperature of 25° C. is greater than 1.1×10⁹. Polymeric Particle Dispersion 1 is mixed first with deionized (DI) water to reach the desired solids fraction for the experiment. This blend is then pumped into the clean vessel and by using stirring and pumping, entrapped air is removed. Prior to initiating agglomeration, Polymeric Particle Dispersion 1 is stirred for 5 minutes at 500 rotations per minute (rpm) to homogenize. Table 4 presents the stirring speeds and the specified amount of salt solution injected via syringe through the port at the bottom of the vessel. Agglomeration size is monitored using LASENTEC (Mettler, Toledo), a focused beam reflectance method (light scattering based). The final average agglomerate size is reported in Table 4. After 40 minutes the stirring is stopped and the vessel discharged. The agglomerated latexes are collected and further analyzed.

TABLE 4

| Description | Trial 1 | Trial 2 |
|---|---|---|
| Polymeric Particle Dispersion 1 (g) | 720 | 820 |
| DI water (g) | 2400 | 2350 |
| Salt Solution (10 weight percent | 70 | 73 |
| calcium chloride) (g) | | |
| Final solid content (%) | 6.5 | 7.3 |
| Stirring speed (rpm) | 1000 | 1000 |
| Aggregation time (min) | 40 | 40 |
| Final average aglomerate size | 41 | 45 |
| (micron) | | |

### Preparation of Formulations and Coating of Substrates

The agglomerated polymeric particles are stirred with a Heidolph high-speed mixer for 15 minutes at 600 rpm. The formulations are mixed with a magnetic stirrer. The coatings are applied on various substrates with an RK instruments lab coater using rod 3 or with a manual draw down bar. The coatings are dried in an oven with an airflow for 2 minutes at 110° C. The rod applies 24 micrometers of wet film and the coat weight varies with solids content within a range of about 1 to 15 grams per square meter (g/m²).

Some of the following latexes used in formulating the coatings, including Polystyrene Latex DPP 3720, Styrene Butadiene Latex DL 935, and NeoCAR Acrylic 820, which are commercially available from The Dow Chemical Company. The precipitated calcium carbonate is supplied by Specialty Minerals, Inc.

Table 5 shows the composition of a Styrene butadiene Latex containing oleic acid as surfactant, identified as FA SB latex in Table 6.

TABLE 5

| Latex Identifier | Stream | Component | Parts | Weight (g) |
|---|---|---|---|---|
| FA SB latex | A | DI Water | 133.78 | 1256.08 |
| | | Seed Latex (38%) | 0.36 | 8.98 |
| | | Sodium Bicarbonate | 0.20 | 1.88 |
| | | Versenol 120 (1%) | 0.01 | 9.39 |
| | B | Styrene | 63.00 | 591.53 |
| | | Oleic Acid | 2.00 | 18.78 |
| | | Acrylic Acid | 1.50 | 14.08 |
| | | Butadiene | 35.50 | 333.32 |
| | | t-Dodecyl Mercaptan | 0.60 | 5.63 |
| | C | DI Water | 20.00 | 187.79 |
| | | Sodium Persulfate | 0.90 | 8.45 |
| | | Sodium Hydroxide | 0.30 | 14.08 |
| | | (20%) | | |

Table 6 shows formulations and comparative formulations with their solids content and pH values for salt-agglomerated polymeric particles. The recipes indicate the normalized grams (dry) of each component that is used in the formulations. The number of parentheses indicates the order of addition.

TABLE 6

| Material | (%) | 1* | 2* | 3 | 4 | 5* | 6 | 7 |
|---|---|---|---|---|---|---|---|---|
| Trial 1 (shown | 6.5 | | | 100 (1) | 50 (3) | | 100 (1) | 50 (1) |
| in Table 4) | | | | | | | | |
| CaCO₃ (HC 60) | 77.4 | | 100 (1) | | | | | |
| DPP 3720 | 55.8 | 100 (1) | | | | | | |
| Sodium oleate | 2.0 | | | 0.3 (2) | 1 (2) | | 0.3 (2) | 0.3 (2) |
| Latex (NeoCAR | 44.3 | | | | 10 (4) | 100 | | 10 (4) |
| Acrylic 820) | | | | | | | | |
| DL 935 | 49.3 | 10 (2) | 10 (2) | | | | | |
| FA SB latex (shown | 38.9 | | | 10 (3) | | | | |
| in Table 5) | | | | | | | | |
| Polymeric Particle | | | | | | | | |
| Dispersion 1 (Shown | 30.6 | | | | | | | 50 (2) |
| in Table 3) | | | | | | | | |
| Precipitated Calcium | 39.4 | | | | 50 (1) | | | |
| Carbonate | | | | | | | | |
| Solids Content | % | 55.1 | 55 | 7.0 | 11.5 | 44.3 | 7.0 | 11.4 |
| pH value | | 6.6 | 8.2 | 7.2 | 7.9 | 8.8 | 7.0 | 7.4 |

*Comparative or base coatings/formulations

Table 7 presents the contact angle, normalized stain size, rolling angle, and Cobb 60s results for coatings prepared from the formulations given in Table 6. The coatings are applied on paper (woodfree 70 g/m², M-real Biberist, Switzerland).

TABLE 7

| | | | | | | | | | 6 on 1 |
|---|---|---|---|---|---|---|---|---|---|
| | 1* | 2* | 3 | 4 | 5* | 6 | 7 | 5 on 1 | on 5 |
| Contact angle, | 64.5 | 84.0 | 138.5 | 148.1 | 89.4 | 141.5 | 147.4 | 88.4 | 133.0 |
| 2 seconds | | | | | | | | | |
| (Degrees) | | | | | | | | | |
| Standard | 3.6 | 3.6 | 3.7 | 3.7 | 3.7 | 2.0 | 2.0 | 4.9 | 5.1 |
| deviation | | | | | | | | | |
| Normalized | 2.58 | 1.79 | 0.60 | 0.55 | 0.37 | 0.57 | 0.51 | 1.67 | 1.57 |
| Stain Size | | | | | | | | | |
| Standard | 0.06 | 0.08 | 0.04 | 0.06 | 0.05 | 0.04 | 0.05 | 0.15 | 0.11 |
| Deviation | | | | | | | | | |
| Rolling Angle | — | — | 12.5 | 10 | — | 12.5 | 10 | — | — |
| Cobb 60 s | — | — | — | — | 0.23 | 18.96 | — | — | — |

*Comparative or base coatings/formulations

As can be seen from Table 7, the latex formulations and compositions using a small amount of fatty acid, such as formulation 3, 4, 6, and 7 provide a coating with a contact angle of about 140 degrees. The coatings, thus, can be described as superhydrophobic coatings.

Table 8 shows formulations and comparative formulations with their solids content and pH values for salt-agglomerated polymeric particles. The Paint LR6 is formulated at The Dow Chemical Company. The recipes indicate the normalized grams (dry) of each component that is used in the formulations. The component with “p” in parenthesis is added as a first component, sodium oleate as the second component (if present), and latex as the last component.

TABLE 8

| Material | (%) | 8 | 9* | 10* | 11 | 12 | 13* | 14 |
|---|---|---|---|---|---|---|---|---|
| Trial 2 (shown | 7.2 | 100 | | | | | | |
| in Table 4) | | | | | | | | |
| CaCO₃ (HC 60) | 76.5 | | | 100 | | | | |
| DPP 3720 | 55.8 | | 100 | | | | | |
| Sodium oleate | 2.0 | 0.3 | | | | | | |
| Latex (NeoCAR | 44.3 | 10.0 | | | | | | |
| Acrylic 820) | | | | | | | | |
| DL 935 | 49.3 | | 10.0 | 10.0 | | | | |
| Formulation 8 (p) | 7.7 | | | | 20.0 | 50.0 | | 100 |
| Paint LR6 (p) | 48.4 | | | | 80.0 | 50.0 | 100 | |
| Colorant (Colanyl | | | | | | | | 6.0 |
| Blue A2R) | | | | | | | | |
| Solids Content | % | 8.5 | 55 | 70.2 | 25.7 | 14.3 | | 8.7 |
| pH value | | 7.1 | 6.4 | 7.9 | 8.7 | 8.3 | 8.8 | 7.1 |

*Comparative or base coatings/formulations

Table 9 presents the contact angle, normalized stain size, rolling angle, and Cobb 60s results for coatings prepared from formulations given in Table 9. The coatings are applied on paper (woodfree 70 g/m², M-real Biberist, Switzerland), plastic (MYLAR, E.I. du Pont de Nemours and Company, Wilmington, Del., USA), contrast chart (Opacity Chart, Leneta Company, Inc., Mahwah N.J., USA), steel (BONDER steel panel, Chemetall GmbH, Frankfurt, Germany), wood (untreated pinewood panel), eternit (Eternit cement panel, Eternit Schweitz AG, Switzerland), and plaster board (Knauf, Germany).

TABLE 9

| | 8 | 9* | 10* | 11 | 12 | 13* | 14 |
|---|---|---|---|---|---|---|---|
| Contact Angle 2 s | | | | | | | |
| (degrees) | | | | | | | |
| Paper | 146.5 | 59.0 | 100.0 | 94.6 | 118.4 | 87.8 | 134.2 |
| Standard Deviation | 2.5 | 3.7 | 1.7 | 3.6 | 3.5 | 4.1 | 5.1 |
| Plastic | 133.1 | 44.1 | 96.4 | 91.9 | 110.7 | 90.0 | 128.8 |
| Standard Deviation | 4.3 | 2.9 | 6.7 | 4.0 | 6.0 | 1.7 | 4.5 |
| Contrast Chart | 142.0 | 37.6 | 88.6 | 89.9 | 115.1 | 85.6 | 139.6 |
| Standard Deviation | 1.1 | 4.1 | 1.9 | 2.8 | 3.5 | 1.6 | 2.5 |
| Normalized Stain | | | | | | | |
| Size | | | | | | | |
| Paper | 0.23 | 3.34 | 1.96 | 1.44 | 1.18 | 1.49 | 0.93 |
| Standard Deviation | 0.01 | 0.34 | 0.13 | 0.05 | 0.12 | 0.12 | 0.05 |
| Plastic | 0.94 | 4.73 | 2.23 | 1.16 | 1.78 | 0.96 | 1.09 |
| Standard Deviation | 0.06 | 0.58 | 0.12 | 0.14 | 0.06 | 0.13 | 0.09 |
| Steel | 0.67 | 5.89 | 2.27 | 1.68 | 1.92 | 1.60 | 1.12 |
| Standard Deviation | 0.05 | 0.88 | 0.07 | 0.08 | 0.18 | 0.04 | 0.09 |
| Wood | | | | 1.74 | | 1.56 | |
| Standard Deviation | | | | 0.13 | | 0.13 | |
| Contrast Chart | 0.91 | ~10 | 2.03 | 0.58 | 1.94 | 1.54 | 0.84 |
| Standard Deviation | 0.06 | | 0.04 | 0.03 | 0.07 | 0.08 | 0.05 |
| Eternit | 1.05 | 4.71 | 1.73 | 1.69 | 3.25 | 1.71 | 1.56 |
| Standard Deviation | 0.15 | 0.18 | 0.05 | 0.09 | 0.20 | 0.04 | 0.43 |
| Plaster Board | 0.62 | ~10 | 3.05 | 1.49 | 2.70 | 1.67 | 3.42 |
| Standard Deviation | 0.03 | | 0.29 | 0.08 | 0.57 | 0.06 | 0.32 |
| Rolling Angle | | | | | | | |
| (Degree) | | | | | | | |
| Paper | 10 | | | | | | 35 |
| Plastic | 30 | | | | | | |
| Steel | 10 | | | | | | 15 |
| Wood | 15 | | | | | | 15 |
| Contrast chart | 15 | | | | | | 25 |
| Eternit | | | | | | | 35 |
| Plaster Board | 10 | | | | | | 13 |

*Comparative or base coatings/formulations

As can be seen from Table 9, the contact angle for formulation 8, in which a fatty acid is used in polymerizing the primary particles for agglomerated polymeric particles (Trial 2), is greater than the other formulations on every surface. In addition, the addition of formulation 8 into the latex Paint LR6, as shown in formulations 11 and 12, increases the hydrophobicity of the latex Paint LR6. For example, the contact angle on paper increases by about 6 degrees in formulation 11, and the contact angle on paper increases by about 30 degrees in formulation 12. In addition, the stain size is less for formulation 8 and the rolling angle is less than or equal to the other formulations on every surface presented.

### Example 3

In this example, the agglomeration with a cationic polymer is provided.

Polymeric Particle Dispersion 2, shown in Table 10, is diluted to a solids content of 10 percent and the pH is reduced to 2.2 with 10 percent hydrochloric acid (HCl). Polyethyleneimine (PEI) (Lupasol G20) is diluted 1:1 with water, and 1.1 grams (g) of the PEI solution is added to 100 g of the diluted Polymeric Particle Dispersion 2 under agitation. The pH is reduced to about 4 with HCl to ensure agglomeration of the polymeric particles. The pH of the PEI treated Polymeric Particle Dispersion 2 is increased to about 9.5 with ammonium hydroxide, and dilution of a few drops in water show the presence of agglomerates, which settle rapidly.

TABLE 10

| Stream | Component | Parts | Weight (Grams) |
|---|---|---|---|
| A | DI Water | 212.72 | 1513.05 |
| | Sodium Bicarbonate | 0.20 | 1.42 |
| | Seed Latex (38%) | 0.12 | 2.33 |
| | Versenol 120 (1%) | 0.01 | 7.11 |
| B | Styrene | 99.50 | 707.73 |
| | Oleic Acid | 2.00 | 14.23 |
| | Acrylic Acid | 0.50 | 3.56 |
| C | DI Water | 26.00 | 184.93 |
| | Sodium Persulfate | 0.70 | 4.98 |
| | Sodium Hydroxide (20%) | 0.30 | 10.67 |

Blends of the PEI treated Polymeric Particle Dispersion 2 with NeoCAR Acrylic 820 are prepared. Coatings of the blends are made on Mylar film using a 600 micron bar and dried at 50 degrees Celsius (° C.). TABLE 11 reports the blends.

TABLE 11

| Material | [%] | PEI-1 | PEI-2 | PEI-3 | PEI-4 |
|---|---|---|---|---|---|
| Polymeric Particle | 10 | 100 | 100 | 100 | 100 |
| Dispersion 2 (shown | | | | | |
| in Table 5) | | | | | |
| PEI | 25 | 1.1 | 1.1 | 1.1 | 1.1 |
| NeoCAR Acrylic 820 | 49 | 3 | 4.5 | 6.1 | 7.75 |

Table 12 provides the contact angle results for coatings prepared with PEI agglomerated polymeric particles.

TABLE 12

| | PEI-1 | PEI-2 | PEI-3 | PEI-4 |
|---|---|---|---|---|
| Contact angle, 2 | 122.7 | 125.6 | 127.1 | 125.0 |
| seconds (degrees) | | | | |
| Standard Deviation | 4.0 | 1.6 | 0.9 | 1.6 |

As can be seen from Table 12, the PEI treated coatings form a highly hydrophobic surface coating. It does not appear that the amount of binder, e.g., NeoCAR Acrylic 820, has a substantial effect on the contact angle.

### Example 4

In this example, the agglomeration with a spray drying process is provided.

The spray drying is performed with NIRO mobile spray dryer. The spray drying parameters in the first experiments are: water evaporation: 1 kilogram/hour (kg/hr); air flow: 80 kg/hr; inlet temperature of drying air: 150° C.; outlet temperature: 50° C.; atomization of dispersion by two component nozzle: 3 bar air pressure/2.2 liters per hour (l/hr) dispersion feed rate; separation of powder and air: cyclone.

Table 13 presents the formulations prepared for spray drying.

TABLE 13

| Material | [%] | F4 | F5 | F6 |
|---|---|---|---|---|
| Polymeric Particle | 30.6 | | 100.0 | |
| Dispersion 1 | | | | |
| (shown in Table 3) | | | | |
| Polymeric Particle | 30.0 | 100.0 | | |
| Dispersion 2 | | | | |
| (shown in Table 10) | | | | |
| NeoCAR 820 | 44.3 | 10.0 | 10.0 | 10.0 |
| NaO1 | 100.0 | 0.1 | 0.1 | 0.1 |
| CaCl2 | 10.0 | 0.05 | 0.01 | 0.025 |
| Solids | % | 30.74 | 29.98 | 31.20 |
| pH-value (10% | | 7.82 | 8.70 | 8.43 |
| NaOH) | | | | |
| Brookfield 100 rpm | mPas | 18.5 | 18 | 18 |
| R1 | | | | |

Table 14 presents the contact angles of coatings prepared from the above-prepared formulations before the spray-drying process.

TABLE 14

| | F4 | F5 | F6 |
|---|---|---|---|
| Contact angle (degrees) | 83.82 | 86.68 | 87.64 |
| Standard deviation | 1.27 | 1.50 | 1.51 |
| (degrees) | | | |

Table 15 describes the results and shows how the particle size can be increased and maintained in re-dispersion.

TABLE 15

| | Dispersion | | | | Powder | | | Re-dispersion | | |
|---|---|---|---|---|---|---|---|---|---|---|
| | Particle | Particle | | | Strainer residue >500 | | | Sedimentation | Sedimentation | Particle |
| | Size mᵥ | Size mₙ | Solid | Yield | microns | Moisture | Ash | 1 hour | 24 hour | Size mᵥ |
| Formulation | (nm) | (nm) | (%) | (g/%) | (g/%) | (%) | (%) | (ml) | (ml) | (nm) |
| F4 | 253 | 219 | 31 | 126.1/89.0 | 0.01/0.01 | 0.5 | 1.5 | 420 | 78 | 3900 |
| F5 | 273 | 219 | 30 | 118.7/85.8 | 0.01/0.01 | 0.3 | 1.0 | 12 | 59 | 2328 |
| F6 | 243 | 209 | 31 | 136.9/90.3 | 0.01/0.01 | 0.4 | 0.8 | 450 | 82 | 5762 |

The results show that reduced carboxylation (F5 and F6 with Polymeric Particle Dispersion 1 versus F4 with Polymeric Particle Dispersion 2) increases particle size after re-dispersion. Further, an increase in salt content increases the particle size.

Table 16 presents the formulations prepared from spray-dried particles (F4, F5, and F6) and Table 17 presents the water contact angles and rolling angles of the formulations on coated paper.

TABLE 16

| Materials | [%] | SD4 | SD5 | SD6 |
|---|---|---|---|---|
| Spray Dry F4 | 100.0 | 100 | | |
| Spray Dry F5 | 100.0 | | 100 | |
| Spray Dry F6 | 100.0 | | | 100 |
| Water | 0.0 | Water as | Water as | Water as |
| | | needed | needed | needed |
| Solids | % | 40 | 40 | 40 |

TABLE 17

| | | | | SD6 with |
|---|---|---|---|---|
| | SD4 | SD5 | SD6 | scrubbing |
| Contact angle | 105.5 | 103.8 | 108.7 | 117.4 |
| (degrees) | | | | |
| Standard | 6.2 | 6.7 | 3.9 | 2.14 |
| deviation | | | | |
| (degrees) | | | | |
| Rolling Angle | 5 | 5 | 8 | |
| (Degrees) | | | | |

As can be seen from Table 17, the contact angle can be increased 20-25 degrees by spray drying the particle pigments as compared to the contact angles presented in Table 14.

Table 18 presents the results of spray drying pure Polymeric Particle Dispersion 1 and the utilization of different spray drying conditions.

TABLE 18

| | Drying Conditions | | | | | | Powder | |
|---|---|---|---|---|---|---|---|---|
| | Solid | Feed Rate | Air Pressure | Inlet Air | Outlet | | Strainer residue >500 | |
| | Feed | Dispersion | Nozzle | Temperature | Temperature | Yield | microns | Moisture |
| | (%) | (l/h) | (bar) | (° C.) | (° C.) | (g/%) | (g/%) | (%) |
| XS 606 | 30 | 2.2 | 3.0 | 130 | 51 | 154.6/85.9 | 0.08/0.04 | 0.3 |
| XS 607 | 30 | 2.2 | 1.5 | 130 | 54 | 165.0/91.7 | 0.05/0.03 | 0.3 |
| XS 608 | 30 | 1.1 | 3.0 | 130 | 61-62 | 121.1/80.7 | 0.01/0.01 | 0.3 |
| XS 609 | 30 | 2.2 | 3.0 | 140 | 57-58 | 131.1/87.4 | 0.01/0.01 | 0.3 |
| XS 610 | 30 | 2.2 | 3.0 | 150 | 62-63 | 129.7/87.4 | 0.01/0.01 | 0.3 |

Table 19 presents the results on particle sizes of spray dried Polymeric Particle Dispersion 1 as well as contact angles of coatings prepared with spray dried Polymeric Particle Dispersion 1 and 30 pph of NeoCAR Acrylic 820.

TABLE 19

| | | | 30 pph of NeoCAR |
|---|---|---|---|
| | | | Acrylic 820 |
| | Particle Size mᵥ | Particle Size mₙ | Contact angle |
| | (nm) | (nm) | (Degrees) |
| XS 606 | 484 | 149 | 130 (±4.8) |
| XS 607 | 2760 | 95 | 126 (±2.7) |
| XS 608 | 2030 | 62 | 131 (±3.8) |
| XS 609 | 4291 | 3631 | 128 (±2.8) |
| XS 610 | 4909 | 187 | 119 (±1.7) |

As can be seen from Table 19, the contact angle can be increased 20-25 degrees by spray drying the particle pigments as compared to the contact angles presented in Table 14.

1. A polymeric particle agglomerate, comprising:
polymeric particles forming the polymeric particle agglomerate, each of the polymeric particles being a polymer having an elastic modulus greater than about 10⁸ Pascal (Pa), measured at 25 degrees Celsius and at a deformation frequency of 1 radian per second, where the polymeric particle is hydrophobic, and where the hydrophobicity is achieved by polymerizing a monomer in a mixture comprising water and a fatty acid, or salt thereof, where the monomer contains less than about 3 parts acid monomer per 100 parts dry monomer, the polymeric particle agglomerate having a volume average particle diameter in a range of 0.5 micrometer to 500 micrometer.

2. The polymeric particle agglomerate of claim 1, where the polymeric particle agglomerate has a volume average particle diameter of 1 micrometer to 50 micrometer.

3. A process, comprising:
polymerizing a monomer in a mixture comprising water, a fatty acid, or salt thereof, and the monomer, where the monomer contains less than 3 parts acid monomer per 100 parts dry monomer under conditions sufficient to produce an aqueous dispersion of polymeric particles, where the polymeric particles contain a polymer with an elastic modulus greater than about 10⁸ Pa, measured at 25° C. and at a deformation frequency of 1 radian per second; and
forming a polymeric particle agglomerate having a volume average particle diameter in a range of 0.5 micrometer to 500 micrometer from the polymeric particles.

4. The process of claim 3, where the process further includes forming the polymeric particle agglomerate from the polymeric particles using a process selected from among:
spray drying the polymeric particles in water to form the polymeric particle agglomerate;
adding a polyvalent salt aqueous solution to the polymeric particles in water to form the polymeric particle agglomerate; and
adding a cationic polymer to the polymeric particles in water to form the polymeric particle agglomerate.

5. (canceled)

6. The process of claim 3, where the process includes mixing the polymeric particle agglomerate with a hydrophobic polymeric binder to form a coating composition.

7. The process of claim 6, where the hydrophobic polymeric binder is a hydrophobic synthetic latex composition.

8. A coating composition comprising the polymeric particle agglomerate of claim 1 where the coating composition can form a hydrophobic coating.

9. (canceled)

10. The coating composition of claim 8, where the hydrophobic coating is superhydrophobic.

11. The coating composition of claim 8, including a hydrophobic polymeric binder having polymers and a fatty acid, or salt thereof, the polymers of the hydrophobic polymeric binder formed by:
polymerizing monomers, where the monomers contain less than 3 parts acid monomer per 100 parts dry monomer, by at least one of emulsion polymerization, miniemulsion polymerization, and dispersion polymerization, where the monomers are selected from a group of: alkyl acrylate, butadiene, C₁-C₁₀ alkyl esters of (meth)acrylic acid, C₄-C₈ dialkyl esters of maleic, itaconic and fumaric acids, vinyl esters of carboxylic acids, styrene, and any mixture thereof.

12. The polymeric particle agglomerate of claim 1, where the monomer is selected from a group of: alkyl acrylate, butadiene, C₁-C₁₀ alkyl esters of (meth)acrylic acid, C₄-C₈ dialkyl esters of maleic, itaconic and fumaric acids, vinyl esters of carboxylic acids, styrene, and any mixture thereof.

13. The polymeric particle agglomerate of claim 1, where the acid monomer is selected from a group of: acrylic acid, methacrylic acid, itaconic acid, fumaric acid, maleic acid, and any mixture thereof.

14. The polymeric particle agglomerate of claim 1, where the fatty acid, or salt thereof, is in a range of about 0.2 parts per 100 parts dry monomer to about 5 parts per 100 parts dry monomer.

15. The polymeric particle agglomerate of claim 1, where the fatty acid, or salt thereof, is selected from a group of: oleic acid, stearic acid, palmitic acid, linoleic acid, linolenic acid, and combinations thereof.

16. The polymeric particle agglomerate of claim 1, including an agglomerating agent selected from a group of: cetyl pyridinium chloride, ethoxylated quaternary ammonium salts, polyethyleneimine, poly(diallyldimethylammonium chloride) and combinations thereof.
